(19) United States
(12) Patent Application Publication
(10) Pub. No.: US 2023/0084948 A1
(43) Pub. Date: Mar. 16, 2023

(54) Wireless Circuitry with Efficient Antenna Tuning

(71) Applicant: Apple Inc., Cupertino, CA (US)

(72) Inventors: Thomas E. Biedka, San Jose, CA (US); James G. Judkins, Campbell, CA (US); Ming-Ju Tsai, Sunnyvale, CA (US); Ramzi N. Aboujaoude, San Jose, CA (US); Theodoros Kamakaris, San Jose, CA (US); Victor C. Lee, Santa Clara, CA (US); Liang Han, Sunnyvale, CA (US)

(21) Appl. No.: 17/554,734

(22) Filed: Dec. 17, 2021

Related U.S. Application Data
(60) Provisional application No. 63/245,059, filed on Sep. 16, 2021.

(51) Int. Cl. H04B 1/00; H01Q 1/24

(52) U.S. Cl. CPC H04B 1/0053; H01Q 1/24

(57) ABSTRACT

An electronic device may include wireless circuitry with a baseband processor, a transceiver, and an antenna. The antenna may be coupled to one or more antenna tuning elements for tuning the antenna over multiple communications (frequency) bands of interest. The baseband processor may be configured to simultaneously broadcast, over a digital interface, an aggregate message that includes control bits for adjusting multiple antenna tuning elements coupled to the digital interface. Adjusting multiple antenna tuning elements by issuing a single broadcast command can help optimize interface efficiency while maintaining compatibility with existing industry standards.

This application claims the benefit of provisional patent application No. 63/245,059, filed Sep. 16, 2021, which is hereby incorporated by reference herein in its entirety.

### FIELD

This disclosure relates generally to electronic devices and, more particularly, to electronic devices with wireless communications circuitry.

### BACKGROUND

Electronic devices are often provided with wireless communications capabilities. An electronic device with wireless communications capabilities has wireless communications circuitry with one or more antennas. Wireless receiver circuitry in the wireless communications circuitry uses the antennas to transmit and receive radio-frequency signals.

To satisfy consumer demand for small form factor wireless devices, manufacturers are continually striving to implement wireless communications circuitry such as antenna components using compact structures. At the same time, there is a desire for wireless devices to cover a growing number of communications bands. It can be challenging to design a wireless device for covering a wide range of frequencies.

### SUMMARY

An electronic device may include wireless communications circuitry. The wireless communications circuitry may include an antenna, a transceiver configured to transmit and receive radio-frequency signals to and from the antenna, and a baseband processor coupled to the transceiver. The antenna may be coupled to multiple antenna tuning elements. The baseband processor or the transceiver may broadcast an aggregate message over a digital interface to simultaneously control the multiple antenna tuning elements for optimal interface efficiency.

An aspect of the disclosure provides one or more antennas, a first antenna tuning element coupled to the one or more antennas, a second antenna tuning element coupled to the one or more antennas, and control circuitry having a digital control interface coupled to the first and second antenna tuning elements. The control circuitry can be configured to broadcast over the digital control interface an aggregate message that includes at least a first control bit for adjusting the first antenna tuning element and at least a second control bit for adjusting the second antenna tuning element. The electronic device can further include a third antenna tuning element coupled to the one or more antennas, where the aggregate message broadcast by the control circuitry over the digital control interface further includes at least a third control bit for adjusting the third antenna tuning element. The electronic device can further include a first register coupled to the first antenna tuning element, the first register being configured to store the first control bit for controlling the first antenna tuning element; a second register coupled to the second antenna tuning element, the second register being configured to store the second control bit for controlling the second antenna tuning element; and a third register coupled to the third antenna tuning element, the third register being configured to store the third control bit for controlling the third antenna tuning element.

The first, second, and third antenna tuning elements can be different types of switches. The first, second, and third antenna tuning elements can be part of a single antenna or separate antennas in the electronic device. The first antenna tuning element can use a first bit mask to identify the first control bit in the aggregate message; the second antenna tuning element can use a second bit mask to identify the second control bit in the aggregate message; and the third antenna tuning element can use a third bit mask to identify the third control bit in the aggregate message. The control circuitry can generate the aggregate message by shifting the first control bit by a first amount, shifting the second control bit by a second amount different than the first amount, and combining the shifted first control bit, the shifted second control bit, and the third control bit into the aggregate message.

An aspect of the disclosure provides a method for operating an electronic device. The method can include tuning an antenna using a first antenna tuning element, tuning the antenna using a second antenna tuning element, generating an aggregate message that includes at least a first control bit for adjusting the first antenna tuning element and at least a second control bit for adjusting the second antenna tuning element, simultaneously broadcasting the aggregate message over a digital interface to the first and second antenna tuning elements, and adjusting the first antenna tuning element using the first control bit in the aggregate message and adjusting the second antenna tuning element using the second control bit in the aggregate message. The method can include detecting a radio state change for the antenna and in response to detecting the radio state change, looking up at least a first new control bit for adjusting the first antenna tuning element corresponding to the detected radio state change and looking up at least a second new control bit for adjusting the second antenna tuning element corresponding to the detected radio state change. The method can include shifting the second new control bit, generating a new aggregate message by combining the first new control and the shifted second new control, simultaneously broadcasting the new aggregate message over the digital interface to the first and second antenna tuning elements, and adjusting the first antenna tuning element using the first new control bit in the new aggregate message and adjusting the second antenna tuning element using the second new control bit in the new aggregate message.

An aspect of the disclosure provides a non-transitory computer-readable storage medium storing one or more programs configured to be executed by one or more processors of an electronic device, where the electronic device comprises wireless circuitry including an antenna. The one or more programs can include instructions for tuning the antenna using a first tunable component, tuning the antenna using a second tunable component, tuning the antenna using a third tunable component, generating an aggregate command that includes at least a first control bit for adjusting the first tunable component, second control bits for adjusting the second tunable component, and third control bits for adjusting the third tunable component, and simultaneously broadcasting the aggregate command over a digital interface to the first, second, and third tunable components. The one or more programs can further include instructions for adjusting the first tunable component using the first control bit, adjusting the second tunable component using the second control bits, and adjusting the third tunable component using the third control bits. The one or more programs can further include instructions for using a first bit mask associated with the first tunable component to extract the first control bit from the aggregate command, using a second bit mask associated with the second tunable component to extract the second control bits from the aggregate command, and using a third bit mask associated with the third tunable component to extract the third control bits from the aggregate command. The instructions for generating the aggregate command can include instructions for selectively shifting the second control bits by a first amount, selectively shifting the third control bits by a second amount different than the first amount, and combining the first control bit, the second control bits, and the third control bits into the aggregate command.

### BRIEF DESCRIPTION OF THE DRAWINGS

FIG. 1 is a diagram of an illustrative electronic device having wireless communications circuitry in accordance with some embodiments.

FIG. 2 is a schematic diagram of illustrative wireless communications circuitry in accordance with some embodiments.

FIG. 3 is a diagram of an illustrative antenna with antenna tuning elements coupled to a digital control interface in accordance with some embodiments.

FIG. 4 is a diagram of multiple antennas having antenna tuning elements coupled to a digital control interface in accordance with some embodiments.

FIG. 5 is a diagram showing the number of control bits for controlling different type of antenna tuning elements in accordance with some embodiments.

FIG. 6 is a diagram showing an aggregate message that can be used to control multiple antenna tuning elements in accordance with some embodiments.

FIG. 7 is a diagram showing a different shifting scheme for generating an aggregate message that can be used to control multiple antenna tuning elements in accordance with some embodiments.

FIG. 8 is a flow chart of illustrative steps for controlling antenna tuning elements via a digital interface in accordance with some embodiments.

### DETAILED DESCRIPTION

An electronic device may be provided with wireless circuitry having one or more antennas. The antennas may each have one or more antenna tuning elements that can be adjusted depending on the current mode of operation. At one operating frequency, the antenna tuning elements may be adjusted to a first state, whereas at another operating frequency, the antenna tuning elements may be adjusted to a second state. A baseband processor or a transceiver in the wireless circuitry may be coupled to the antenna tuning elements via a digital interface. The baseband processor (or the transceiver) may broadcast an aggregate message on the digital interface. The aggregate message may include bits for controlling each of the antenna tuning elements. Operated in this way, the antenna tuning elements can be efficiently programmed while maintaining backwards compatibility with existing interface standards.

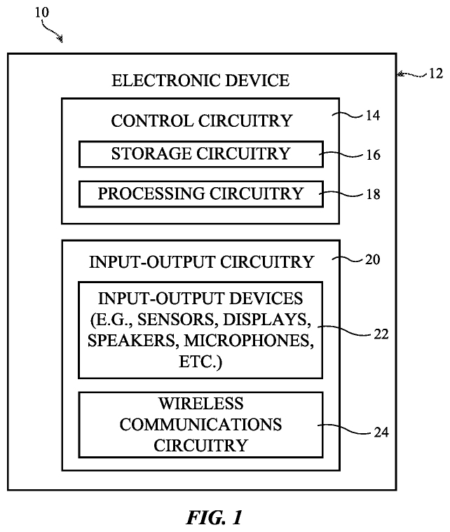

FIG. 1 is a diagram of an electronic device such as electronic device 10 that can be provided with such antenna tuning circuitry. Electronic device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the schematic diagram FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more microprocessors, microcontrollers, digital signal processors, host processors, baseband processor integrated circuits, application specific integrated circuits, central processing units (CPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 5G New Radio (NR) protocols, etc.), MIMO protocols, antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, electronic pencil (e.g., a stylus), and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 24 may include wireless communications circuitry such as wireless communications circuitry 34 (sometimes referred to herein as wireless circuitry 24) for wirelessly conveying radio-frequency signals. While control circuitry 14 is shown separately from wireless communications circuitry 24 for the sake of clarity, wireless communications circuitry 24 may include processing circuitry that forms a part of processing circuitry 18 and/or storage circuitry that forms a part of storage circuitry 16 of control circuitry 14 (e.g., portions of control circuitry 14 may be implemented on wireless communications circuitry 24). As an example, control circuitry 14 (e.g., processing circuitry 18) may include baseband processor circuitry or other control components that form a part of wireless communications circuitry 24.

Wireless communications circuitry 24 may include radio-frequency (RF) transceiver circuitry formed from one or more integrated circuits, power amplifier circuitry configured to amplify uplink radio-frequency signals (e.g., radio-frequency signals transmitted by device 10 to an external device), low-noise amplifiers configured to amplify downlink radio-frequency signals (e.g., radio-frequency signals received by device 10 from an external device), passive radio-frequency components, one or more antennas, transmission lines, and other circuitry for handling radio-frequency wireless signals. Wireless signals can also be sent using light (e.g., using infrared communications).

Wireless circuitry 24 may include radio-frequency transceiver circuitry for handling transmission and/or reception of radio-frequency signals in various radio-frequency communications bands. For example, the radio-frequency transceiver circuitry may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz), or other cellular communications bands between about 600 MHz and about 5000 MHz (e.g., 3G bands, 4G LTE bands, 5G New Radio Frequency Range 1 (FR1) bands below 10 GHz, 5G New Radio Frequency Range 2 (FR2) bands at millimeter and centimeter wavelengths between 20 and 60 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), an ultra-wideband (UWB) communications band supported by the IEEE 802.15.4 protocol and/or other UWB communications protocols (e.g., a first UWB communications band at 6.5 GHz and/or a second UWB communications band at 8.0 GHz), and/or any other desired communications bands. The communications bands handled by such radio-frequency transceiver circuitry may sometimes be referred to herein as frequency bands or simply as “bands,” and may span corresponding ranges of frequencies. In general, the radio-frequency transceiver circuitry within wireless circuitry 24 may cover (handle) any desired frequency bands of interest.

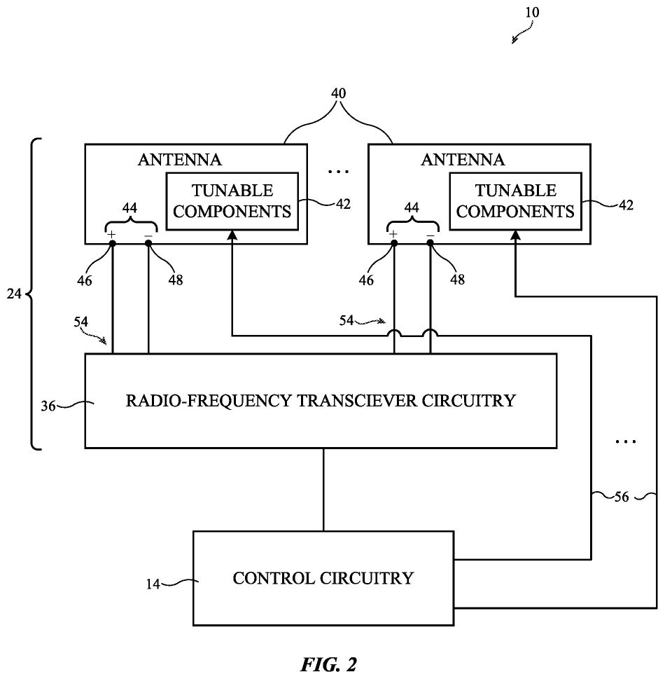

FIG. 2 is a diagram of illustrative wireless communications circuitry 24 for device 10. As shown in FIG. 2, wireless circuitry 24 may include radio-frequency transceiver circuitry 36 for handling various radio-frequency communications bands. Transceiver circuitry 36 may include wireless local area network (WLAN) and wireless personal area network (WPAN) transceiver circuitry. Transceiver circuitry 36 may handle 2.4 GHz and 5 GHz bands for WiFi® (IEEE 802.11) communications or other WLAN bands and may handle the 2.4 GHz Bluetooth® communications band or other WPAN bands. Circuitry 36 may also include cellular telephone transceiver circuitry for handling wireless communications in frequency ranges (communications bands) between 600 MHz and 6 GHz and/or other cellular communications bands such as a cellular low band (LB) from 600 to 960 MHz, a cellular low-midband (LMB) from 1410 to 1510 MHz, a cellular midband (MB) from 1710 to 2170 MHz, a cellular high band (HB) from 2300 to 2700 MHz, a cellular ultra-high band (UHB) from 3300 to 5850 MHz, or other communications bands between 600 MHz and 5850 MHz (e.g., a frequency between 500 MHz and 6 GHz) or other suitable frequencies (as examples). The cellular telephone transceiver circuitry may handle voice data and non-voice data.

If desired, circuitry 36 may include satellite navigation system circuitry such as Global Positioning System (GPS) receiver circuitry for receiving GPS signals at 1575 MHz or for handling other satellite positioning data (e.g., GLONASS signals at 1609 MHz). Satellite navigation system signals for circuitry 36 are received from a constellation of satellites orbiting the earth. Circuitry 36 can include circuitry for other short-range and long-range wireless links if desired. For example, circuitry 36 may include circuitry for receiving television and radio signals, paging system transceivers, near field communications (NFC) transceiver circuitry (e.g., an NFC transceiver operating at 13.56 MHz or another suitable frequency), etc.

In NFC links, wireless signals are typically conveyed over a few inches at most. In satellite navigation system links, cellular telephone links, and other long-range links, wireless signals are typically used to convey data over thousands of feet or miles. In WLAN and WPAN links at 2.4 and 5 GHz and other short-range wireless links (e.g., WiFi® links at 2.4-8 GHz), wireless signals are typically used to convey data over tens or hundreds of feet. Antenna diversity schemes may be used if desired to ensure that antennas that have become blocked or that are otherwise degraded due to the operating environment of device 10 can be switched out of use and higher-performing antennas used in their place.

Transceiver circuitry 36 may include ultra-wideband (UWB) transceiver circuitry that supports communications using the IEEE 802.15.4 protocol and/or other ultra-wideband communications protocols. In an IEEE 802.15.4 system, a pair of electronic devices may exchange wireless time stamped messages. Time stamps in the messages may be analyzed to determine the time of flight of the messages and thereby determine the distance (range) between the devices and/or an angle between the devices (e.g., an angle of arrival of incoming radio-frequency signals). UWB transceiver circuitry in circuitry 36 may operate at one or more ultra-wideband communications frequencies between about 5 GHz and about 8.3 GHz, between 3 GHz and 10 GHz, and/or at other frequencies (e.g., a 6.5 GHz UWB communications band, an 8 GHz UWB communications band, and/or bands at other suitable frequencies). As an example, device 10 may transmit and/or receive radio-frequency signals at ultra-wideband frequencies with external wireless equipment to determine a distance between device 10 and the external wireless equipment and/or to determine an angle of arrival of radio-frequency signals (e.g., to determine the relative orientation and/or position of the external wireless equipment with respect to device 10). The external wireless equipment may be an electronic device in system 8 such as device 10 or may include any other desired wireless equipment. Radio-frequency signals handled by device 10 in an ultra-wideband communications band and using an ultra-wideband communications protocol may sometimes be referred to herein as ultra-wideband signals. Radio-frequency signals transmitted and/or received by device 10 in other communications bands (e.g., using communications protocols other than an ultra-wideband communications protocol) may sometimes be referred to here as non-ultra-wideband (non-UWB) signals. Non-UWB signals handled by device 10 may include, for example, radio-frequency signals in a cellular telephone communications band, a WLAN communications band, etc.

Wireless circuitry 24 may include antennas 40. Antennas 40 may be formed using any suitable types of antenna structures. For example, antennas 40 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of two or more of these designs, etc. If desired, one or more of antennas 40 may be cavity-backed antennas.

Different types of antennas may be used for different bands and combinations of bands. For example, one type of antenna may be used in forming a local wireless link antenna and another type of antenna may be used in forming a remote wireless link antenna. Dedicated antennas may be used for conveying radio-frequency signals in a particular band. For example, antennas 40 may be configured to handle only cellular telephone signals or only wireless local area network signals. If desired, antennas 40 may only handle signals for a UWB communications band (e.g., UWB signals) or antennas 40 can be configured to convey both radio-frequency signals in a UWB communications band and radio-frequency signals in non-UWB communications bands (e.g., wireless local area network signals and/or cellular telephone signals). Antennas 40 can include two or more antennas for handling signals in a given band (e.g., to implement a MIMO scheme). For example, at least two, at least four, or other set of multiple antennas 40 may be used by circuitry 36 to handle cellular signals.

Space may be at a premium in electronic device 10. In order to minimize space consumption within device 10, the same antenna 40 may be used to cover multiple communications bands. For example, each antenna 40 may be used to cover multiple cellular telephone bands between 600 MHz and 6 GHz and/or other suitable frequency range.

In general, transceiver circuitry 36 may include one or more radio-frequency transceivers (e.g., GPS receiver circuitry, WLAN/WPAN circuitry, cellular telephone transceiver circuitry, and/or UWB transceiver circuitry). Transceiver circuitry 36 may be coupled to antennas 40 using radio-frequency transmission line path such as radio-frequency transmission line paths 54.

To provide antenna structures such as antennas 40 with the ability to cover communications frequencies of interest, antennas 40 may be provided with circuitry such as filter circuitry (e.g., one or more passive filters and/or one or more tunable filter circuits). Discrete components such as capacitors, inductors, and resistors may be incorporated into the filter circuitry. Capacitive structures, inductive structures, and resistive structures may also be formed from patterned metal structures (e.g., part of an antenna).

In accordance with some embodiments, antennas 40 may be provided with adjustable circuits such as tunable components 42 to tune the antennas over communications (frequency) bands of interest. Tunable components 42 may be part of a tunable filter or tunable impedance matching network, may be part of an antenna resonating element, may span a gap between an antenna resonating element and antenna ground, etc.

Tunable components 42 may include switches, tunable inductors, tunable capacitors, tunable resistors, and/or other adjustable components. Tunable components such as these may be based on switches and networks of fixed components, distributed metal structures that produce associated distributed capacitances and inductances, variable solid-state devices for producing variable capacitance and inductance values, tunable filters, or other suitable tunable structures. During operation of device 10, control circuitry 14 may issue control signals on one or more control paths that adjust switches, inductance values, capacitance values, resistance values, impedance values, or other parameters associated with tunable components 42, thereby tuning antennas 40 to cover desired communications bands. Antenna tuning components that are used to adjust the frequency response of antennas 40 such as tunable components 42 may sometimes be referred to herein as antenna tuning components, tuning components, antenna tuning elements, antenna tuning circuits, tuning (tunable) elements, adjustable tuning components, adjustable tuning elements, switches, or adjustable components.

Radio-frequency transmission lines 54 may include positive and ground signal paths. Radio-frequency transmission lines 54 may include coaxial cable transmission lines, stripline transmission lines, microstrip transmission lines, structures implemented using metalized vias, edge-coupled microstrip transmission lines, edge-coupled stripline transmission lines, waveguide structures (e.g., coplanar waveguides or grounded coplanar waveguides), combinations of these types of radio-frequency transmission lines and/or other transmission line structures.

If desired, the positive signal conductor and ground signal conductor of each radio-frequency transmission line 54 may be formed from metal traces on rigid and/or flexible printed circuits. In one suitable arrangement, radio-frequency transmission lines may include metal traces integrated within multilayer laminated structures (e.g., layers of a conductive material such as copper or other metal and a dielectric material such as a resin that are laminated together with or without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to accommodate other device components and may be rigid enough to hold its shape after folding without being held in place by stiffeners or other structures).

A matching network (e.g., an adjustable matching network formed using tunable components 42) may include components such as inductors, resistors, and capacitors used in matching the impedance of each antenna 40 to the impedance of a respective radio-frequency transmission line 54. Matching network components may be provided as discrete components (e.g., surface mount technology components) or may be formed from housing structures, printed circuit board structures, traces on polymer supports, etc. Components such as these may also be used in forming filter circuitry in antenna 40 and may be tunable and/or fixed components. In some configurations, the presence of the user's head near antennas 40 may affect antenna performance (e.g., antenna resonating frequency and/or input impedance). Impedance matching circuitry for antennas 40 may be configured to help accommodate altered antenna impedance characteristics exhibited when device 10 is being worn on the head versus when device 10 is not being worn on the head. Switches in components 42 may, as an example, be adjusted depending on whether device 10 is in an on-head or off-head operating mode.

Radio-frequency transmission lines 54 may be coupled to antenna feed structures associated with antennas 40. As an example, each antenna 40 may form an inverted-F antenna, a slot antenna, a monopole antenna, a dipole antenna, or other antenna having an antenna feed with a positive antenna feed terminal such as positive antenna feed terminal 46 and a ground antenna feed terminal such as ground antenna feed terminal 48. Other types of antenna feed arrangements may be used if desired. If desired, antennas 40 may be fed using multiple feeds each coupled to a respective port of radio-frequency transceiver circuitry 36 over a corresponding radio-frequency transmission line path. In some configurations, transmission line paths may be coupled to multiple locations on a given antenna (e.g., an antenna may include multiple positive antenna feed terminals coupled to a signal conductor of a radio-frequency transmission line). Switches may be interposed on the signal lines between radio-frequency transceiver circuitry 36 and the positive antenna feed terminals if desired (e.g., to selectively activate one or more positive antenna feed terminals at any given time). The illustrative feeding configuration of FIG. 2 is merely illustrative.

Antennas 40 may include antenna resonating element structures (sometimes referred to herein as radiating element structures), antenna ground plane structures (sometimes referred to herein as ground plane structures, ground structures, or antenna ground structures), an antenna feed such as antenna feeds 46 and 48, and other components (e.g., tunable components 42). Antennas 40 may be configured to form any suitable type of antenna.

During operation of device 10, control circuitry 14 may issue control signals on one or more paths such as path 56 that adjust switch states, inductance values, capacitance values, or other parameters associated with tunable components 42, thereby tuning antenna 40 to cover desired communications bands. Path 56 may be a digital control interface configured to convey control messages (commands). An example, one or more baseband processors within control circuitry 14 may be configured to output control bits for adjusting tunable components 42. This example in which control bits are conveyed from control circuitry 14 to tunable components 42 via paths 56 is merely illustrative. As another example, tunable components 42 may receive control bits from radio-frequency transceiver circuitry 36 (e.g., the transceiver can also generate control signals for adjusting tunable components 42 for tuning antenna 42 to cover different communications bands).

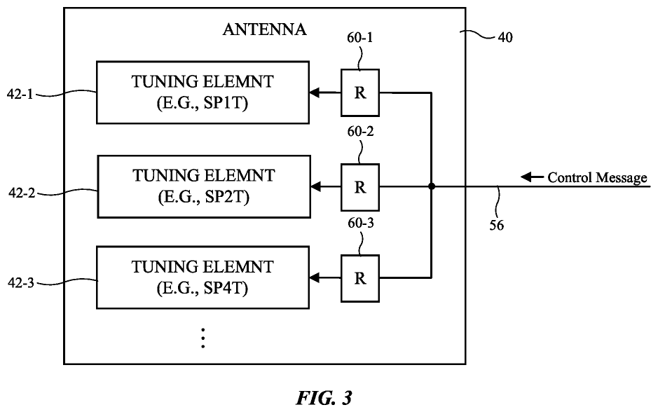

FIG. 3 is a diagram of an illustrative antenna 40 with tunable components (sometimes referred to as antenna tuning elements) 42 coupled to a digital control interface 56. As described above in connection with FIG. 2, one or more processors in control circuitry 14 (e.g., one or more baseband processors) or transceiver circuitry 36 may send control bits in the form of a control message over digital interface 56 to adjust the antenna tuning elements 42. In the example of FIG. 3, digital interface 56 is coupled to multiple tuning elements 42 within a single antenna 40. For instance, digital interface 56 may be coupled to a first tuning element 42-1, a second tuning element 42-2, and a third tuning element 42-3. Antenna tuning elements 42-1, 42-2, and 42-3 may be different types of switches. Tuning element 42-1 may be a single pole single throw (SP1T) switch (e.g., an on-off switch with one input and output). Tuning element 42-2 may be a single pole double throw (SP2T) switch (e.g., a switch with one input that can connect to and switch between two outputs). Tuning element 42-3 may be a single pole four throw (SP4T) switch (e.g., a switch with one input that can connect to and switch among four outputs).

Each tunable component may be controlled using control bits stored at respective digital storage components such as registers 60. Tuning element 42-1 may be programmed by control bits stored at associated register 60-1. Tuning element 42-2 may be programmed by control bits stored at associated register 60-2. Tuning element 42-3 may be programmed by control bits stored at associated register 60-3. This example in which a single digital interface 56 is coupled to three different antenna tuning elements 42 is merely illustrative. In another embodiment, digital interface 56 may be coupled to fewer than three different tunable components in the same antenna 40 or in different antennas 40. In yet another embodiment, digital interface 56 may be coupled to more than three different tunable components in the same antenna 40 or in different antennas 40. The example of FIG. 3 in which antenna tuning elements 42 are switches is also merely illustrative. These switches can be used to switch in or out inductors, capacitors, resistors, or other passive electrical components. In general, each tuning element 42 can represent any type of switch, tunable filter circuit, tunable impedance matching circuit, a tunable component for configuring the wireless circuitry in a high performance mode or a low performance mode, a tunable component for configuring the wireless circuitry in a high voltage mode or a low voltage mode, a tunable component for configuring the wireless circuitry in a high current mode or a low current mode, or other tunable component that can adjust the performance or characteristics of antenna(s) 40 or wireless circuitry 24.

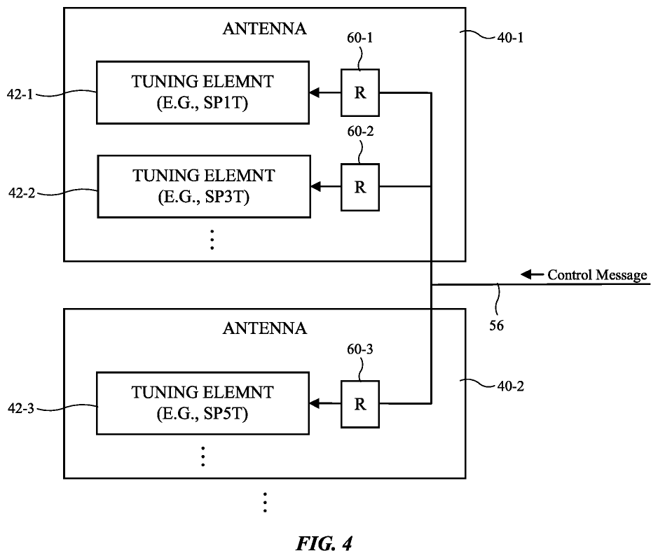

FIG. 4 is a diagram showing how digital interface 56 may be coupled to antenna tuning elements 42 within different antennas 40. As shown in FIG. 4, digital interface 56 may be coupled to tuning elements 42-1 and 42-2 within a first antenna 40-1 and may be coupled to tuning elements 42-3 within a second antenna 40-2. Antenna tuning elements 42-1, 42-2, and 42-3 of FIG. 4 may be different types of switches. Tuning element 42-1 may be a single pole single throw (SP1T) switch. Tuning element 42-2 may be a single pole triple throw (SP3T) switch (e.g., a switch with one input that can connect to and switch among three outputs). Tuning element 42-3 may be a single pole five throw (SP5T) switch (e.g., a switch with one input that can connect to and switch among five outputs). Each tunable component may be controlled using control bits stored at respective digital storage components such as registers 60. Tuning element 42-1 may be programmed by control bits stored at associated register 60-1. Tuning element 42-2 may be programmed by control bits stored at associated register 60-2. Tuning element 42-3 may be programmed by control bits stored at associated register 60-3. In general, digital interface 56 can be coupled to any number of antennas, and each antenna can include any number of tuning elements 42. Some antennas may not include any tuning elements 42.

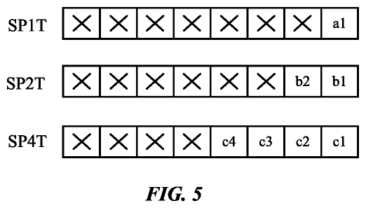

Digital interface 56 may be an 8-bit digital interface (as an example). Unlike other relatively more complex radio-frequency circuits such as power amplifiers or low noise amplifiers that might require many control bits to adjust the gain and power settings of those circuits, antenna tuning elements 42 such as switches (e.g., SP1T switches, SP2T switches, SP3T switches, SP4T switches, SP5T switches, etc.) can be programmed using a relatively small number of control bits. FIG. 5 shows the number of bits required to program three different antenna tuning switches. As shown in FIG. 5, a SP1T antenna tuning switch only needs one control bit in an 8-bit word, as shown by bit a1. The remaining 7 bits in the control word marked as “x” represent don't care bits. An SP2T antenna tuning switch only needs two control bits in an 8-bit word, as shown by bits b1 and b2. The remaining 6 bits in the control word are don't-care bits. An SP4T antenna tuning switch only needs four control bits in an 8-bit word, as shown by bits c1, c2, c3, and c4. The remaining 4 bits in the control word are don't-care bits.

One way of controlling or programming the three switches of FIG. 5 is to send three different control words over the 8-bit digital interface in a sequential manner. During a first time period, a first control word containing bit a1 in the least significant bit (LSB) position may be sent to a digital register (see, e.g., register 60-1 in FIG. 3) controlling that SP1T antenna tuning switch. During a second time period after the first time period, a second control word containing bits b1 and b2 in the two LSB positions may be sent to the digital register controlling that SP2T antenna tuning switch. During a third time period after the second time period, a third control word containing bits c1-c4 in the four LSB positions may be sent to the digital register controlling that SP4T antenna tuning switch. This way of sending three different control words in sequence may not be the most efficient way of utilizing the digital control interface.

In accordance with an embodiment, a baseband processor or a transceiver may be configured to issue a broadcast command that is simultaneously sent to all components coupled to the digital interface. The broadcast command may be used to instruct all connected devices to execute a common function such as a wake or shutdown command. The broadcast command may, for example, include an aggregate message that includes control bits for all of the associated antenna tuning switches.

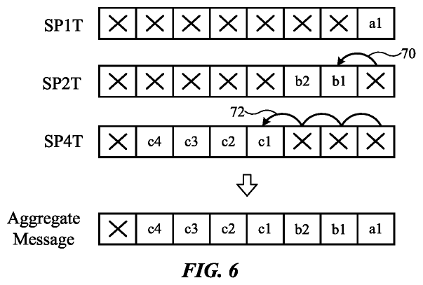

FIG. 6 illustrates an aggregate message that can be broadcast to three different antenna tuning switches. As shown in FIG. 6, the aggregate message may include bit a1 for controlling the SP1T switch in the LSB position, bits b1 and b2 shifted over by one bit position to the left (as shown by arrow 70) for controlling the SP2T switch, and bits c1-c4 shifted over by three bit positions to the left (as shown by arrow 72) for controlling the SP4T switch. These control bits may be stored in the digital register associated with each antenna tuning switch (see, e.g., registers 60 in FIGS. 3 and 4). The creator of the aggregate message may know in advance where to shift the control bits for each corresponding antenna tuning element. In other words, the control bits for different antenna tuning bits are selectively shifted and compressed into a single control message (command). In this particular example, the resulting 8-bit aggregate message that includes control bits for multiple antenna tuning switches has only one don't-care bit.

This aggregate message can be simultaneously broadcast to the three different antenna tuning switches, and each of the switches will know which bits to use as control bits. For instance, the SP1T switch will only consider the LSB as its control bit while masking out or ignoring the other bits. The SP2T switch will only consider the relevant b1 and b2 bits in the aggregate message while masking out or ignoring the remaining bits. Similarly, the SP4T switch will only consider the relevant c1-c4 bits in the aggregate message while masking out or ignoring the remaining bits. The bit masking setting or information can also be stored at the digital register associated with each antenna tuning switch (see, e.g., registers 60 in FIGS. 3 and 4). Controlling multiple antenna tuning elements by simultaneously broadcasting a single message (command) with all the control bits aggregated in one message in this way is a much more efficient way of controlling the antenna tuning elements over the digital interface while maintaining backwards compatibility with existing interface standards.

The description above describing how each switch uses a bit mask to filter out (extract) only the relevant control bits from the aggregate message is merely illustrative. In another embodiment, each antenna tuning element may be informed by how much to shift the aggregate message before examining the LSBs. For example, the SP4T switch may shift the aggregate message four bits to the right before using the four resulting LSBs as control (programming) bits. The SP2T may first shift the aggregate message one bit to the right before using the two resulting LSBs as control (programming) bits. The SP1T need not shift the aggregate message at all since the a1 control bit is already in the LSB position. The amount of shift needed at each antenna tuning switch can also be stored at the digital register associated with each antenna tuning switch (see, e.g., registers 60 in FIGS. 3 and 4). This programmable amount of bit shift for each antenna tuning element may be configured early on in the operation of device 10 to minimize operational overhead.

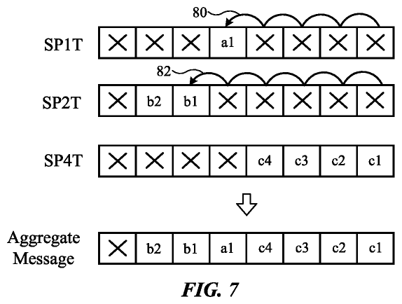

The example of FIG. 6 in which the smaller number of control bits sit at the lower bit positions is merely illustrative. FIG. 7 shows another allocation of control bits for three different types of antenna tuning switches. As shown in FIG. 7, the aggregate message may include bit a1 shifted over by four bit positions to the left (as shown by arrow 80) for controlling the SP1T switch, bits b1 and b2 shifted over by five bit position to the left (as shown by arrow 82) for controlling the SP2T switch, and bits c1-c4 in the un-shifted LSB positions for controlling the SP4T switch. The creator of the aggregate message may know in advance where to shift the control bits for each corresponding antenna tuning element. In other words, the control bits for different antenna tuning bits are selectively shifted and compressed into a single control message (command). In this particular example, the resulting 8-bit aggregate message that includes control bits for multiple antenna tuning switches has only one don't-care bit, which takes advantage of the available bit-width of the digital interface for optimal efficiency.

This aggregate message can be simultaneously broadcast to the three different antenna tuning switches, and each of the switches will know which bits to use as control bits. For instance, the SP1T switch will only consider the relevant a1 bit as its control bit while masking out or ignoring the other bits. The SP2T switch will only consider the relevant b1 and b2 bits in the aggregate message while masking out or ignoring the remaining bits. Similarly, the SP4T switch will only consider the relevant c1-c4 LSBs in the aggregate message while masking out or ignoring the remaining bits. Controlling multiple antenna tuning elements by simultaneously broadcasting a single message (command) with all the control bits aggregated in one message in this way is a much more efficient way of controlling the antenna tuning elements over the digital interface while maintaining backwards compatibility with existing interface standards.

The description above describing how each switch uses a bit mask to filter out (extract) only the relevant control bits from the aggregate message is merely illustrative. In another embodiment, each antenna tuning element may be informed by how much to shift the aggregate message before examining the LSBs. For example, the SP4T switch may simply use the four LSBs as control (programming) bits. The SP2T may first shift the aggregate message five bits to the right before using the two resulting LSBs as control (programming) bits. The SP1T may shift the aggregate message four bits to the right before using the resulting LSB as the control (programming) bit. This programmable amount of bit shift for each antenna tuning element may be configured early on in the operation of device 10 to minimize operational overhead.

The examples described above in which the digital interface coupled to the antenna tuning elements is 8 bits wide is merely illustrative. In general, the digital interface can have a bit width that is greater than 8 bits, less than 8 bits, at least 15 bits, at least 16 bits, 16-32 bits, at least 32 bits, 32-64 bits, at least 64 bits, or greater than 64 bits. The aggregate control message (sometimes referred to as the control word or control command) can include at least 4 bits (including control bits and don't-care bits), at least 8 bits (including control bits and don't-care bits), at least 15 bits (including control bits and don't-care bits), at least 16 bits (including control bits and don't-care bits), at least 24 bits (including control bits and don't-care bits), at least 32 bits (including control bits and don't-care bits), at least 48 bits (including control bits and don't-care bits), at least 64 bits (including control bits and don't-care bits), or other suitable amount of bits for simultaneously controlling any desired number of antenna tuning elements.

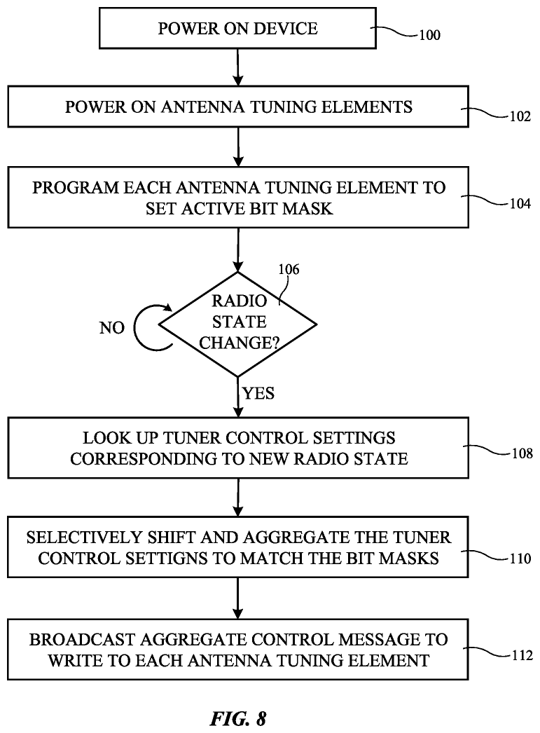

FIG. 8 is a flow chart of illustrative steps for controlling antenna tuning elements via a shared digital interface. During the operations of block 100, electronic device 10 may be initially powered on. During the operations of block 102, device 10 may power on the antenna tuning elements 42 and the associated digital registers 60 controlling those elements. At this time, the antenna tuning elements 42 may optionally be configured with initial control bits to enable the wireless circuitry to operate in an initial radio-frequency band.

During the operations of block 104, one or more baseband processors or the transceiver may program each antenna tuning element to set the active bit mask. For the example of FIG. 7, the SP1T antenna tuning switch may be programmed with a first bit mask that passes through the fifth bit position in the aggregate message; the SP2T antenna tuning switch may be programmed with a second bit mask that passes through the sixth and seventh bit positions in the aggregate message; and the SP4T antenna tuning switch may be programmed with a third bit mask that passes through the four LSB positions in the aggregate message. Thus, the bit mask for each antenna tuning element can be used to extract the relevant control bits.

Alternatively, each antenna tuning element may be programmed by a configurable shift amount. For the example of FIG. 6, the SP1T antenna tuning switch may be programmed with a shift amount of 0 since the a1 bit is already in the LSB position; the SP2T antenna tuning switch may be programmed with a shift amount of one since the b1 and b2 bits are in the second and third bit positions in the aggregate message; and the SP4T antenna tuning switch may be programmed with a shift amount of three since the c1-c4 bits are in the 4-7th bit positions in the aggregate message.

During the operations of block 106, device 10 may monitor for a radio state change. A radio state change may be defined as a change in operating frequency or a change in the radio-frequency communications band. In response to detecting a change in the operating frequency, processing may proceed to the operations of block 108.

During the operations of block 108, the control circuitry (e.g., the baseband processor or transceiver) may look up new antenna tuning control settings corresponding to the new radio state. For example, the control circuitry may consult a lookup table stored in storage circuitry 18 to determine the desired control bit settings for each of the antenna tuning elements that need to be adjusted.

During the operations of block 110, the control circuitry may obtain the new control bit settings for each of the antenna tuning elements, selectively shift the bits by a predetermined amount (as described in connection with the examples of FIGS. 6 and 7), and combine the resulting bits to generate an aggregate control message. The control bits for each antenna tuning element in the aggregate message should correspond to the bit mask locations programmed during the operations of block 104.

During the operations of block 112, the control circuitry may simultaneously broadcast the aggregate control message over the digital interface to each of the antenna tuning elements coupled to the digital interface. Each antenna tuning element may receive the aggregate message, selectively obtain the relevant control bits using the pre-programming bit mask or by selectively shifting the aggregate message by the pre-programmed amount, and then write in the new control bit settings to the associated digital register.

The operations of FIG. 8 are merely illustrative. At least some of the described operations may be modified or omitted; some of the described operations may be performed in parallel; additional processes may be added or inserted between the described operations; the order of certain operations may be reversed or altered; the timing of the described operations may be adjusted so that they occur at slightly different times, or the described operations may be distributed in a system.

The methods and operations described above in connection with FIGS. 1-8 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless communications circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 of FIG. 1, etc.). The processing circuitry may include microprocessors, application processors, digital signal processors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. An electronic device comprising:
one or more antennas;
a first antenna tuning element coupled to the one or more antennas;
a second antenna tuning element coupled to the one or more antennas; and
control circuitry having a digital control interface coupled to the first and second antenna tuning elements, the control circuitry configured to broadcast over the digital control interface an aggregate message that includes at least a first control bit for adjusting the first antenna tuning element and at least a second control bit for adjusting the second antenna tuning element.

2. The electronic device of claim 1, further comprising:
a first register coupled to the first antenna tuning element, the first register being configured to store the first control bit for controlling the first antenna tuning element; and
a second register coupled to the second antenna tuning element, the second register being configured to store the second control bit for controlling the second antenna tuning element.

3. The electronic device of claim 1, further comprising:
a third antenna tuning element coupled to the one or more antennas, wherein the aggregate message broadcast by the control circuitry over the digital control interface further includes at least a third control bit for adjusting the third antenna tuning element.

4. The electronic device of claim 3, further comprising:
a first register coupled to the first antenna tuning element, the first register being configured to store the first control bit for controlling the first antenna tuning element;
a second register coupled to the second antenna tuning element, the second register being configured to store the second control bit for controlling the second antenna tuning element; and
a third register coupled to the third antenna tuning element, the third register being configured to store the third control bit for controlling the third antenna tuning element.

5. The electronic device of claim 3, wherein the first, second, and third antenna tuning elements comprise different types of switches.

6. The electronic device of claim 3, wherein the control circuitry comprises one or more processors configured to generate baseband signals.

7. The electronic device of claim 3, wherein the control circuitry comprises a radio-frequency transceiver coupled between a baseband processor and the antenna.

8. The electronic device of claim 3, wherein the first, second, and third antenna tuning elements are part of a single antenna in the electronic device.

9. The electronic device of claim 3, wherein:
the first and second antenna tuning elements are part of a first antenna in the electronic device; and
the third antenna tuning element is part of a second antenna in the electronic device.

10. The electronic device of claim 3, wherein:
the first antenna tuning element uses a first bit mask to identify the first control bit in the aggregate message;
the second antenna tuning element uses a second bit mask to identify the second control bit in the aggregate message; and
the third antenna tuning element uses a third bit mask to identify the third control bit in the aggregate message.

11. The electronic device of claim 3, wherein the control circuitry is configured to generate the aggregate message by:
shifting the first control bit by a first amount;
shifting the second control bit by a second amount different than the first amount; and
combining the shifted first control bit, the shifted second control bit, and the third control bit into the aggregate message.

12. A method of operating an electronic device, the method comprising:
tuning an antenna using a first antenna tuning element;
tuning the antenna using a second antenna tuning element;
generating an aggregate message that includes at least a first control bit for adjusting the first antenna tuning element and at least a second control bit for adjusting the second antenna tuning element;
simultaneously broadcasting the aggregate message over a digital interface to the first and second antenna tuning elements; and
adjusting the first antenna tuning element using the first control bit in the aggregate message and adjusting the second antenna tuning element using the second control bit in the aggregate message.

13. The method of claim 12, further comprising:
detecting a radio state change for the antenna; and
in response to detecting the radio state change, looking up at least a first new control bit for adjusting the first antenna tuning element corresponding to the detected radio state change and looking up at least a second new control bit for adjusting the second antenna tuning element corresponding to the detected radio state change.

14. The method of claim 13, further comprising:
shifting the second new control bit;
generating a new aggregate message by combining the first new control and the shifted second new control;
simultaneously broadcasting the new aggregate message over the digital interface to the first and second antenna tuning elements; and
adjusting the first antenna tuning element using the first new control bit in the new aggregate message and adjusting the second antenna tuning element using the second new control bit in the new aggregate message.

15. The method of claim 12, further comprising:
using a first bit mask at the first antenna tuning element to extract the first control bit from the aggregate message; and
using a second bit mask at the second antenna tuning element to extract the second control bit from the aggregate message.

16. The method of claim 15, further comprising:
storing the first control bit at a first register coupled to the first antenna tuning element; and
storing the second control bit at a second register coupled to the second antenna tuning element.

17. A non-transitory computer-readable storage medium storing one or more programs configured to be executed by one or more processors of an electronic device, wherein the electronic device comprises wireless circuitry including an antenna, the one or more programs including instructions for:
tuning the antenna using a first tunable component;
tuning the antenna using a second tunable component;
tuning the antenna using a third tunable component;
generating an aggregate command that includes at least a first control bit for adjusting the first tunable component, second control bits for adjusting the second tunable component, and third control bits for adjusting the third tunable component; and
simultaneously broadcasting the aggregate command over a digital interface to the first, second, and third tunable components.

18. The non-transitory computer-readable storage medium of claim 17, the one or more programs further including instructions for:
adjusting the first tunable component using the first control bit;
adjusting the second tunable component using the second control bits; and
adjusting the third tunable component using the third control bits.

19. The non-transitory computer-readable storage medium of claim 17, the one or more programs further including instructions for:
using a first bit mask associated with the first tunable component to extract the first control bit from the aggregate command;
using a second bit mask associated with the second tunable component to extract the second control bits from the aggregate command; and
using a third bit mask associated with the third tunable component to extract the third control bits from the aggregate command.

20. The non-transitory computer-readable storage medium of claim 17, wherein the instructions for generating the aggregate command comprises instructions for:
selectively shifting the second control bits by a first amount;
selectively shifting the third control bits by a second amount different than the first amount; and
combining the first control bit, the second control bits, and the third control bits into the aggregate command.
